(19) United States
(12) Patent Application Publication
(10) Pub. No.: US 2025/0056380 A1
(43) Pub. Date: Feb. 13, 2025

(54) METHOD FOR DETECTING WIRELESS COMMUNICATION CHANNEL AND WIRELESS COMMUNICATION DEVICE

(71) Applicant: Realtek Semiconductor Corporation, Hsinchu (TW)

(72) Inventor: Chun-Chu CHANG, Hsinchu (TW)

(21) Appl. No.: 18/430,673

(22) Filed: Feb. 2, 2024

(30) Foreign Application Priority Data
Aug. 11, 2023 (TW) 112130386

(51) Int. Cl. H04W 48/08; H04W 28/02; H04W 74/0833

(52) U.S. Cl. CPC H04W 48/08; H04W 28/0284; H04W 28/0289; H04W 74/0833

(57) ABSTRACT

A method for detecting wireless communication channel includes following steps of: detecting a wireless communication signal of a wireless communication channel by a wireless communication device to determine whether to generate an idle channel evaluation signal; counting a random back-off period by the wireless communication device according to the idle channel evaluation signal; recording a plurality of channel state parameters by the wireless communication device; generating a channel state result according to the plurality of channel state parameters by the wireless communication device; and determining an operation mode of the wireless communication device according to the channel state result.

### CROSS-REFERENCE TO RELATED APPLICATION

This application claims priority to Taiwan Application Serial Number 112130386, filed on Aug. 11, 2023, which is herein incorporated by reference in its entirety.

### BACKGROUND

### Field of Invention

The present disclosure relates to a communication method and an electronic device. More particularly, the present disclosure relates to a method for detecting wireless communication channel and a wireless communication device.

### Description of Related Art

IEEE (Institute of Electrical and Electronics Engineers, Inc) 802.11e proposes two channel access mechanisms: an enhanced distributed channel access (EDCA) mechanism and a hybrid coordination function (HCF) controlled channel Access (HCCA) mechanism. EDCA is relatively practical. EDCA is a contention-based channel access mechanism that can be configured to build ad hoc network. HCCA is a controlled channel access mechanism, and requires a QAP (QOS Access Point) to build a network.

Then, congestion detections of conventional EDCA-based wireless sensor network include a plurality of parameters. Applicable situations of each of parameters are different, and it is impossible to evaluate how many wireless communication devices are competing for a current wireless communication channel.

For the foregoing reason, there is a need to provide a suitable method for detecting wireless communication channel to solve the problems of the prior art.

### SUMMARY

One aspect of the present disclosure provides a method for detecting wireless communication channel. The method for detecting wireless communication channel includes following steps: detecting a wireless communication signal of a wireless communication channel by a wireless communication device to determine whether to generate an idle channel evaluation signal; counting a random back-off period by the wireless communication device according to the idle channel evaluation signal; recording a plurality of channel state parameters by the wireless communication device; generating a channel state result according to the plurality of channel state parameters by the wireless communication device; and determining an operation mode of the wireless communication device according to the channel state result.

Another aspect of the present disclosure provides a wireless communication device. The wireless communication device includes a channel detection circuit, a random back-off circuit, a channel congestion statistics circuit, a channel congestion analysis circuit and a situational decision circuit. The channel detection circuit is configured to detect a wireless communication signal of a wireless communication channel to determine whether to generate an idle channel evaluation signal. The random back-off circuit is coupled to the channel detection circuit, and is configured to count a random back-off period according to the idle channel evaluation signal. The channel congestion statistics circuit is coupled to the random back-off circuit, and is configured to record a plurality of channel state parameters of the random back-off period. The channel congestion analysis circuit is coupled to the channel congestion statistics circuit, and is configured to generate a channel state result according to the plurality of channel state parameters. The situational decision circuit is coupled to the channel congestion analysis circuit, and is configured to determine an operation mode of the wireless communication device according to the channel state result.

In view of the aforementioned shortcomings and deficiencies of the prior art, the present disclosure provides a method for detecting wireless communication channel and a wireless communication device, which enables a wireless communication device to evaluate whether a wireless communication channel currently being used is in a congestion state, thereby enabling a wireless communication device to flexibly adjust operations.

### BRIEF DESCRIPTION OF THE DRAWINGS

The present disclosure can be more fully understood by reading the following detailed description of the embodiment, with reference made to the accompanying drawings as follows:

FIG. 1 depicts a schematic diagram of wireless communication device according to some embodiments of the present disclosure;

FIG. 2 depicts a flow chart of a method for detecting wireless communication channel according to some embodiments of the present disclosure; and

FIG. 3 depicts a timing diagram of a wireless communication device in a single contention channel according to some embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The terminology used herein is for the purpose of describing particular example embodiments only and is not intended to be limiting of the present disclosure. As used herein, the singular forms “a,” “an” and “the” are intended to include the plural forms as well, unless the context clearly indicates otherwise.

Furthermore, it should be understood that the terms, “comprising”, “including”, “having”, “containing”, “involving” and the like, used herein are open-ended, that is, including but not limited to.

The terms used in this specification and claims, unless otherwise stated, generally have their ordinary meanings in the art, within the context of the disclosure, and in the specific context where each term is used. Certain terms that are used to describe the disclosure are discussed below, or elsewhere in the specification, to provide additional guidance to the practitioner skilled in the art regarding the description of the disclosure.

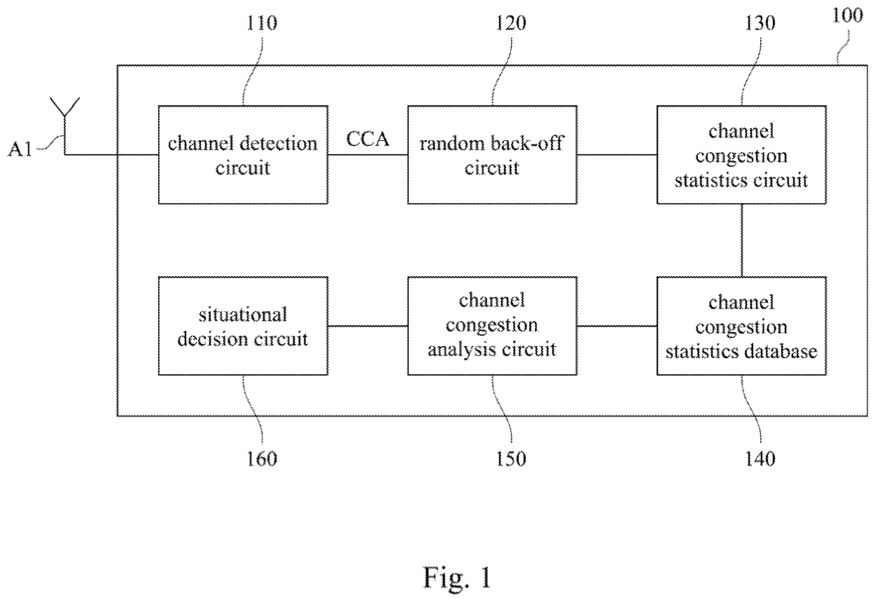

FIG. 1 depicts a schematic diagram of wireless communication device 100 according to some embodiments of the present disclosure. In some embodiments, please refer to FIG. 1, the wireless communication device 100 includes a channel detection circuit 110, a random back-off circuit 120, a channel congestion statistics circuit 130, a channel congestion statistics database 140, a channel congestion analysis circuit 150 and a situational decision circuit 160. The random back-off circuit 120 is coupled to the channel detection circuit 110. The channel congestion statistics circuit 130 is coupled to the random back-off circuit 120. The channel congestion analysis circuit 150 is indirectly coupled to the channel congestion statistics circuit 130 through the channel congestion statistics database 140. The situational decision circuit 160 is coupled to the channel congestion analysis circuit 150. The channel congestion statistics database 140 is coupled between the channel congestion statistics circuit 130 and the channel congestion analysis circuit 150.

In some embodiments, please refer to FIG. 1, the channel detection circuit 110 is configured to detect a wireless communication signal of a wireless communication channel to determine whether to generate an idle channel evaluation signal CCA. The random back-off circuit 120 is configured to count a random back-off period according to the idle channel evaluation signal. The channel congestion statistics circuit 130 is configured to record a plurality of channel state parameters of the random back-off period. It should be noted that the idle channel evaluation signal CCA is mainly divided into signals detected by energy detection (ED) and carrier sense (CS). Energy detection is to determine whether signal energy of a wireless signal received directly through a physical layer of a network exceeds a preset threshold to determine whether there is a wireless signal for access. Carrier sense is to identify whether a specific signal of preamble data at a top of a physical layer convergence protocol (PLCP header) of a WIFI packet of IEEE 802.11 wireless communication standard is received to determine whether there is a wireless signal for access.

Then, the channel congestion analysis circuit 150 is configured to generate a channel state result according to the plurality of channel state parameters. The situational decision circuit 160 is configured to determine an operation mode of the wireless communication device according to the channel state result.

In some embodiments, the channel congestion statistics database 140 is configured to store the plurality of channel state parameters.

In some embodiments, the channel detection circuit 110 includes an antenna A1. The antenna A1 is configured to transmit and receive detection signals to detect whether there is a wireless communication signal of a wireless communication channel is an environment where the wireless communication device 100 is located. If the antenna A1 detects the wireless communication signal, the channel detection circuit 110 is further configured to generate the idle channel evaluation signal CCA so as to transmit the idle channel evaluation signal CCA to the random back-off circuit 120 to stop the random back-off circuit 120 from counting the random back-off period.

In some embodiments, the random back-off circuit 120 is configured to count an arbitration inter-frame space (AIFS) period and the (random back-off) period according to a wireless local area network standard. The wireless local area network standards include IEEE 802.11 wireless communication standard.

In some embodiments, the channel congestion statistics circuit 130 is further configured to record a total number of interruptions during the random back-off period. The above interruption occurs because the random back-off circuit 120 receives the idle channel evaluation signal CCA, and the random back-off circuit 120 is stopped, causing an interruption. The channel congestion statistics circuit 130 is configured to record the channel maximum idle time that is not stopped due to the idle channel evaluation signal CCA during the random back-off period and record the random back-off count value of the random back-off period and the termination mark of the arbitration inter-frame space period. After the random back-off circuit 120 counts the random back-off period, the channel congestion statistics circuit 130 is further configured to use the total number of interruptions, the channel maximum idle time and the termination mark as a plurality of channel state parameters to store in the channel congestion statistics database 140.

In some embodiments, the channel congestion analysis circuit 150 is further configured to calculate a channel congestion evaluation value according to the total number of interruptions and the random back-off count value. The channel congestion analysis circuit 150 is configured to compare the channel congestion evaluation value with a preset congestion value to generate a channel state result.

In some embodiments, if the channel state result is determined to be that the channel congestion evaluation value is less than the preset congestion value, the situational decision circuit 160 is further configured not to adjust the operation mode of the wireless communication device 100. In some embodiments, if the channel state result is determined to be that the channel congestion evaluation value is greater than the preset congestion value, the situational decision circuit 160 is further configured to adjust the operation mode of the wireless communication device 100.

In some embodiments, after the random back-off circuit 120 counts the random back-off period and no wireless communication signal transmitted in the wireless communication channel is detected, the wireless communication device 100 is further configured to transmit a data signal through the wireless communication channel. In some embodiments, after the random back-off circuit 120 counts the random back-off period and does not collide with data signals of other wireless communication devices, the wireless communication device 100 is further configured to transmit the data signal through the wireless communication channel.

In some embodiments, please refer to FIG. 1, the channel congestion statistics circuit 130 is further configured to record whether data signals in the wireless communication channel collide to generate a collision mark.

In some embodiments, the channel detection circuit 110, the random back-off circuit 120, the channel congestion statistics circuit 130, the channel congestion statistics database 140, the channel congestion analysis circuit 150 and the situational decision circuit 160 can be integrated into a microprocessor (not shown in the figure).

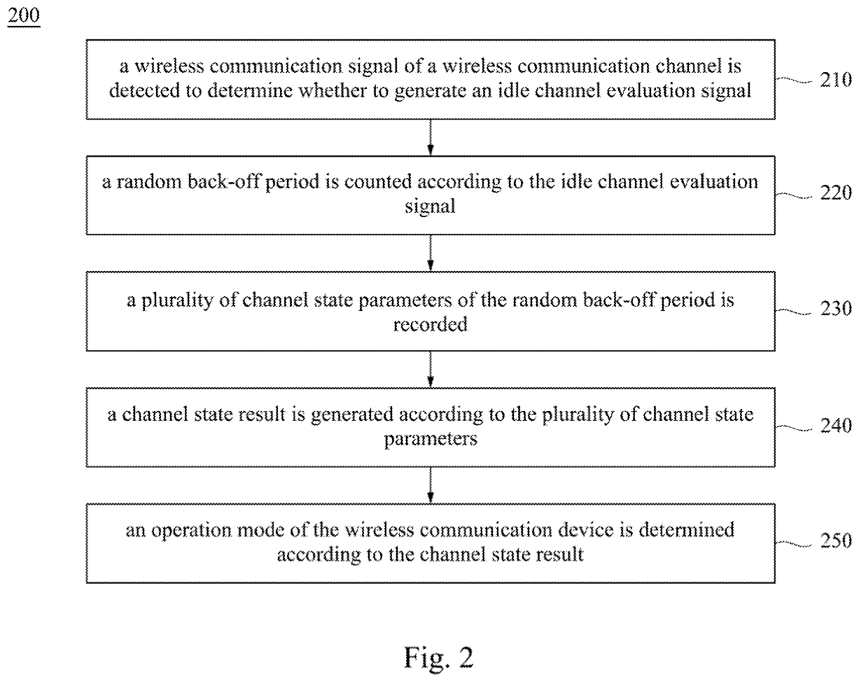

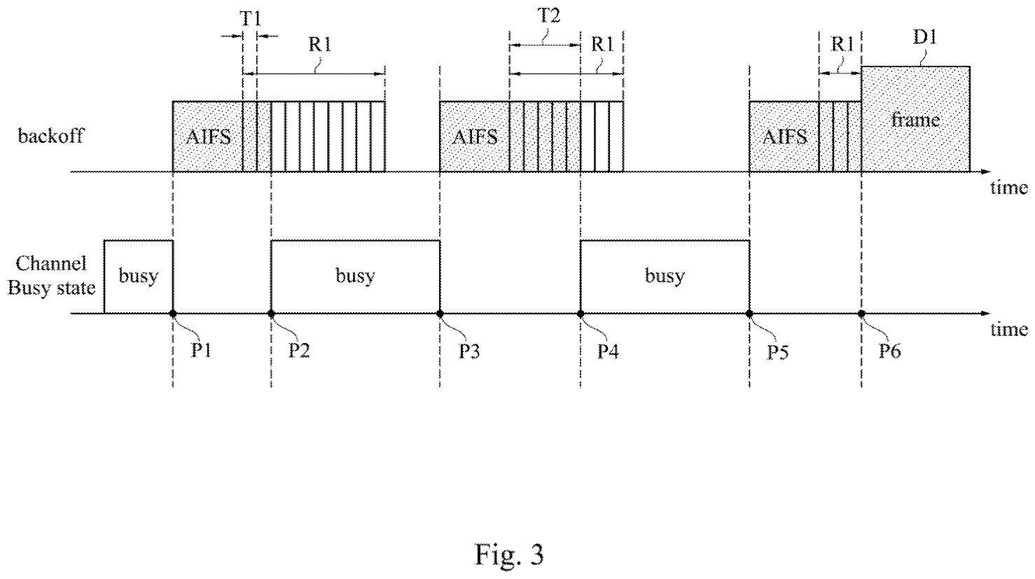

FIG. 2 depicts a flow chart of a method for detecting wireless communication channel 200 according to some embodiments of the present disclosure. In some embodiments, in order to facilitate the understanding the method for detecting wireless communication channel 200 of the present disclosure, please refer to FIG. 1 to FIG. 3 together. FIG. 3 depicts a timing diagram of the wireless communication device 100 in FIG. 1 in a single contention channel according to some embodiments of the present disclosure. In some embodiments, the method for detecting wireless communication channel 200 can be executed by the wireless communication device 100 in FIG. 1. Following description will be according to the embodiment in FIG. 3. It should be that the embodiment in FIG. 3 is a schematic diagram of a channel busy state in which the wireless communication device 100 competes with other with wireless communication devices for the same wireless communication channel at a time.

To further illustrate, the timing diagram in an upper half of FIG. 3 is a timing diagram of the random back-off circuit 120 of the wireless communication device 100 counting arbitration inter-frame space periods AIFS and a random back-off period R1. The timing diagram in a lower half of FIG. 3 is a timing diagram of channel congestion states that the wireless communication channel wireless communication device 100 competes for.

In step 210, a wireless communication signal of a wireless communication channel is detected to determine whether to generate an idle channel evaluation signal.

For example, please refer to FIG. 1 to FIG. 3, the antenna A1 of the channel detection circuit 110 of the wireless communication device 100 in FIG. 1 is configured to detect a wireless communication signal of a wireless communication channel to determine whether to generate an idle channel evaluation signal CCA. Once wireless communication signal is detected, the channel congestion state of the wireless communication channel will be displayed as a busy state in FIG. 3.

In addition, when the channel detection circuit 110 does not detect the wireless communication signal at a first time point P1, the wireless communication device 100 executes step 220.

In step 220, a random back-off period is counted according to the idle channel evaluation signal.

For example, when the channel detection circuit 110 does not detect the wireless communication signal at the first time point P1, the random back-off circuit 120 of the wireless communication device 100 is configured to count the arbitration inter-frame space period AIFS and the random back-off period R1 according to IEEE 802.11 wireless communication standard. After the random back-off circuit 120 of the wireless communication device 100 counts the arbitration inter-frame space period AIFS, the random back-off circuit 120 of the wireless communication device 100 counts according to a random back-off count value. Please refer to the leftmost random back-off period R1 in FIG. 3, there are 10 time slots during the random back-off period R1. The random back-off count value is the 10 time slots.

In some embodiments, a channel time slot T1 defines a time interval for serial operation of time slot messages of a single channel. A duration of an unit time slot is approximately 9 microseconds (μs). In some embodiments, time slots will be different for different frequency bands. For example, time slots in the 5 GHz frequency band is 9 microseconds (μs) long. Time slots in the 2.4 GHz frequency band is 9 microseconds (μs) or 20 microseconds (μs). In some embodiments, a value of the random back-off count value ranges from 1 to 1024.

Then, when the channel detection circuit 110 detects the wireless communication signal at a second time point P2, the channel detection circuit 110 of the wireless communication device 100 is configured to generate an idle channel evaluation signal CCA to stop the random back-off circuit 120 counting the random back-off period R1. At this time, the random back-off circuit 120 has counted 2 time slots out of 10 time slots, and has 8 time slots left to be counted. It should be noted that time slots in which outlets are used in the figure are the counting completed time slots. Time slots in which outlets are not used in the figure are time slots to be counted.

Furthermore, when the channel detection circuit 110 does not detect the wireless communication signal at a third time point P3, the random back-off circuit 120 of the wireless communication device 100 is configured to recount the arbitration inter-frame space period AIFS and continue to count the random back-off count value (i.e., the aforementioned 8 time slots to be counted) of the aforementioned random back-off period R1 according to IEEE 802.11 wireless communication standard. When the channel detection circuit 110 detects the wireless communication signal at a fourth time point P4, the channel detection circuit 110 is configured to generate the idle channel evaluation signal CCA again to stop the random back-off circuit 120 counting the random back-off period R1. At this time, the random back-off circuit 120 has finished counting 5 time slots out of the remaining 8 time slots, and 3 time slots remain to be counted.

Thereafter, when the channel detection circuit 110 does not detect the wireless communication signal at a fifth time point P5, the random back-off circuit 120 of the wireless communication device 100 is configured to recount the arbitration inter-frame space period AIFS and continue to count the random back-off count value (i.e., 3 time slots after the fourth time point P4) to be counted of the aforementioned random back-off period R1 according to IEEE 802.11 wireless communication standard. After the random back-off circuit 120 finish counting the random back-off period R1 at a sixth time point P6, the wireless communication device 100 is configured to transmit a data signal D1 through the wireless communication channel. A data form of the data signal D1 includes at least one of voice data, image data, text data and web page data.

It should be noted that, during the arbitration inter-frame space period AIFS, channel detection circuit 110 may detect the wireless communication signal to end the arbitration inter-frame space period AIFS. A detection of wireless communication signal during the arbitration inter-frame space period AIFS means that there may be illegal data flows or extremely high-priority data flows competing for this wireless communication channel. At this time, the channel congestion statistics circuit 130 of the wireless communication device 100 is configured to record a situation of the ended arbitration inter-frame space period AIFS as a termination mark.

To further illustrate, at the sixth time point P6, the data signal D1 of the wireless communication device 100 may be transmitted to the same wireless communication channel simultaneously with data signals of other wireless communication devices, and a collision may occur. At this time, the channel congestion statistics circuit 130 of the wireless communication device 100 is configured to record the collision situation as a collision mark, and cause the random back-off circuit 120 of the wireless communication device 100 to compete for the wireless communication channel again.

In step 230, a plurality of channel state parameters of the random back-off period is recorded.

For example, please refer to FIG. 1 to FIG. 3, and following the aforementioned example, the channel congestion statistics circuit 130 of the wireless communication device 100 is configured to record the plurality of channel state parameters of the random back-off period R1. In some embodiments, the plurality of channel state parameters include at least one of a total number of interruptions, a channel maximum idle time T2, the random back-off count value and the termination mark.

In some embodiments, the channel congestion statistics circuit 130 of the wireless communication device 100 is configured to record the total number of interruptions due to the idle channel evaluation signal CCA that is stopped during the random back-off period R1. Following the aforementioned examples, at the second time point P2 and the fourth time point P4, the total number of interruptions due to the idle channel evaluation signal CCA that is stopped is 2 times.

In some embodiments, the channel congestion statistics circuit 130 of the wireless communication device 100 is configured to record the channel maximum idle time T2 that is not stopped due to the idle channel evaluation signal CCA during the random back-off period R1. Following the aforementioned examples, please refer to FIG. 1 to FIG. 3, Between the first time point P1 and the sixth time point P6, the longest time that the random back-off circuit 120 of the wireless communication device 100 counts the random back-off period R1 without stopping due to the idle channel evaluation signal CCA is the channel maximum idle time T2. The channel maximum idle time T2 is 5 unit interval time.

In some embodiments, the channel congestion statistics circuit 130 of the wireless communication device 100 is configured to record the random back-off count value of the random back-off period R1. Following the aforementioned examples, please refer to FIG. 1 to FIG. 3, the random back-off count value of random back-off period R1 is 10 time slots. The plurality of channel state parameters recorded by the channel congestion statistics circuit 130 during the random back-off period R1 are organized in following table.

TABLE 1

| | | channel | random | | |
|---|---|---|---|---|---|
| termination | total | maximum | back-off | time | |
| mark | number of | idle time | count | point of | |
| (IFS_ | interruptions | (max_ | value | competition | collision |
| blocking_ | (Back-off_ | nonstop_ | (back-off_ | channel | mark |
| flag) | stop_times) | period) | cnt) | (Tx_tsf) | (ctn_fail) |
| 0 | 2 | 5 (slot | 10 | P6 | 0 |
| | | times) | | | |

In step 240, a channel state result is generated according to the plurality of channel state parameters.

For example, please refer to FIG. 1 to FIG. 3, the channel congestion analysis circuit 150 of the wireless communication device 100 is further configured to calculate the channel congestion evaluation value according to the total number of interruptions and the random back-off count value. The channel congestion analysis circuit 150 is configured to compare the channel congestion evaluation value with a preset congestion value so as to generate a channel state result. A method of calculating the channel congestion evaluation value is summarized below.

$$Stop\_freq = ( Backoff\_stop \_times / backoff\_cnt ) \times 100 \% . \qquad Formula 1$$

In Formula 1, Stop_freq is the aforementioned channel congestion evaluation value. Back-off_stop_times is the aforementioned total number of interruptions. back-off_cnt is the aforementioned random back-off count value.

Following the aforementioned example, the channel congestion analysis circuit 150 is configured to calculate the channel congestion evaluation value Stop_freq of the competitive wireless communication channel to be 20% according to the Formula 1. Then, a type of the wireless communication channel is a best-effort data channel (AC_BE), and its preset congestion value is 40%. The situational decision circuit 160 is configured to compare the channel congestion evaluation value Stop_freq and the preset congestion value to generate the channel state result that the channel congestion evaluation value Stop_freq is less than the preset congestion value.

In some embodiments, a type of the wireless communication channel includes one of a voice data channel (AC_VI), a video data channel (AC_VO), a best-effort data channel (AC_BE) and a background data channel (AC_BK). In some embodiments, an order of priority of wireless communication channel is the video data channel, the voice data channel, the best-effort data channel and the background data channel.

In step 250, an operation mode of the wireless communication device is determined according to the channel state result.

For example, please refer to FIG. 1 to FIG. 3 and table 1, if the channel state result determined by the situational decision circuit 160 is that the channel congestion evaluation value Stop_freq is less than the preset congestion value, the wireless communication device 100 is configured not to adjust the operation mode of the wireless communication device 100. If the channel state result determined by the situational decision circuit 160 is that the channel congestion evaluation value Stop_freq is greater than the preset congestion value, the wireless communication device 100 is configured to adjust the operation mode of the wireless communication device 100.

In some embodiments, the wireless communication device 100 configured to adjust the operation mode of the wireless communication device 100 by entering an Enhanced Multilink Single-Radio (EMLSR) mode, specifying a transmission channel, and adjusting a quality of network service configuration (quality of service, QoS).

In some embodiments, the wireless communication device 100 will compete for the wireless communication channel multiple time. The random back-off period of multiple contention wireless communication channel includes a first random back-off period and a second random back-off period. The plurality of the channel state parameters include a plurality of first channel state parameters and a plurality of second channel state parameters. The first channel state parameters include one of a first number of interruptions, a first channel maximum idle time, a first random back-off count value and a first termination mark. The second channel state parameters include one of a second number of interruptions, a second channel maximum idle time, a second random back-off count value and a second termination mark. It should be noted that the wireless communication device 100 is further configured to calculate and record congestion statistics for multiple times competing with other wireless communication devices for the same wireless communication channel.

In some embodiments, the channel congestion analysis circuit 150 is configured to generate the total number of interruptions according to the first number of interruptions, the second number of interruptions and the collision mark. The channel congestion analysis circuit 150 is configured to generate the random back-off count value according to the first random back-off count value, the second random back-off count value and the collision mark.

For example, the channel congestion statistics circuit 130 of the wireless communication device 100 is configured to organize a congestion statistics data of five times competing with wireless communication devices for the same wireless communication channel as follows.

TABLE 2

| | | channel | random | | |
|---|---|---|---|---|---|
| termination | total | maximum | back-off | time | |
| mark | number of | idle time | count | point of | |
| (IFS_ | interruptions | (max_ | value | competition | collision |
| blocking_ | (Back-off_ | nonstop_ | (back-off_ | channel | mark |
| flag) | stop_times) | period) | cnt) | (Tx_tsf) | (ctn_fail) |
| 0 | 15 | 4 | 42 | 11 | 0 |
| 0 | 4 | 3 | 13 | 12 | 1 |
| 0 | 28 | 6 | 67 | 13 | 1 |
| 0 | 59 | 7 | 122 | 14 | 0 |
| 0 | 1 | 5 | 6 | 15 | 0 |

It should be noted that time points 11˜15 of competition channel of table 2 are time points when the wireless communication device competes with other wireless communication devices for the same wireless communication channel five times in a row.

In some embodiments, the channel congestion statistics circuit 130 is further configured to calculate multiple channel congestion evaluation values as follows.

$$Formula 2$$

$$Avg . Stop\_freq = ( \frac{sum\_Backoff \_stop \_times + sum\_ctn \_fail}{sum\_backoff \_cnt ++ sum\_ctn \_fail} ) \times 100 \% .$$

In Formula 2, Avg. Stop_freq is a channel congestion evaluation value for multiple competing channels. sum_Back-off_stop_times is a sum of the total numbers of interruptions for multiple competing channels. sum_back-off_cnt is a sum of the random back-off count values for multiple competing channels. sum_ctn_fail is a sum of collision marks.

Then, the channel congestion analysis circuit 150 is configured to calculate the channel congestion evaluation value Avg. Stop_freq for multiple competing channels according to Formula 2 to be 43%. Then, a type of the wireless communication channel is best-effort data channel (AC_BE), and its preset congestion value is 40%. The situational decision circuit 160 is configured to compare the channel congestion evaluation value Avg. Stop_freq with the preset congestion value to generate the channel state result that the channel congestion evaluation value Avg. Stop_freq is greater than the preset congestion value. The situational decision circuit 160 of the wireless communication device 100 is configured to adjust the operation mode of the wireless communication device 100.

The present disclosure provides a method for detecting wireless communication channel that is a detection improvement method based on a Enhanced Distributed Channel Access (EDCA) mechanism. The present disclosure further improves shortcomings of EDCA to make EDCA more perfect.

Based on the above embodiments, the present disclosure provides a method for detecting wireless communication channel and a wireless communication device to quantify a busyness of a wireless communication channel so that a wireless communication device can evaluate whether a wireless communication channel currently being used is in a congestion state, and further determine whether to adjust an operation mode of a wireless communication device.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A method for detecting wireless communication channel, comprising:
detecting a wireless communication signal of a wireless communication channel by a wireless communication device to determine whether to generate an idle channel evaluation signal;
counting a random back-off period by the wireless communication device according to the idle channel evaluation signal;
recording a plurality of channel state parameters by the wireless communication device;
generating a channel state result according to the plurality of channel state parameters by the wireless communication device; and
determining an operation mode of the wireless communication device according to the channel state result.

2. The method for detecting wireless communication channel of claim 1, wherein detecting the wireless communication signal of the wireless communication channel by the wireless communication device to determine whether to generate the idle channel evaluation signal comprises:
generating the idle channel evaluation signal by the wireless communication device to stop counting the random back-off period if the wireless communication signal is detected; and
counting an arbitration inter-frame space period and continuing to count the random back-off period by the wireless communication device if the wireless communication signal is not detected.

3. The method for detecting wireless communication channel of claim 2, wherein the channel state parameters comprise one of a total number of interruptions, a channel maximum idle time, a random back-off count value and a termination mark, wherein recording the plurality of channel state parameters by the wireless communication device comprises:
recording the total number of interruptions due to the idle channel evaluation signal that is stopped during the random back-off period by the wireless communication device;
recording the channel maximum idle time that is not stopped due to the idle channel evaluation signal during the random back-off period by the wireless communication device; and
recording the random back-off count value of the random back-off period and the termination mark of the arbitration inter-frame space period by the wireless communication device.

4. The method for detecting wireless communication channel of claim 3, wherein generating the channel state result according to the plurality of channel state parameters by the wireless communication device comprises:
calculating a channel congestion evaluation value according to the total number of interruptions and the random back-off count value by the wireless communication device; and
comparing the channel congestion evaluation value with a preset congestion value by the wireless communication device to generate the channel state result.

5. The method for detecting wireless communication channel of claim 4, wherein comparing the channel congestion evaluation value with the preset congestion value by the wireless communication device to generate the channel state result comprises:
not adjusting the operation mode of the wireless communication device by the wireless communication device if the channel state result is determined that the channel congestion evaluation value is less than the preset congestion value.

6. The method for detecting wireless communication channel of claim 5, wherein comparing the channel congestion evaluation value with the preset congestion value by the wireless communication device to generate the channel state result further comprises:
adjusting the operation mode of the wireless communication device by the wireless communication device if the channel state result is determined that the channel congestion evaluation value is greater than the preset congestion value.

7. The method for detecting wireless communication channel of claim 6, further comprising:
transmitting a data signal through the wireless communication channel by the wireless communication device after the wireless communication device counts the random back-off period; and
recording whether the data signal transmitted by the wireless communication channel encounters a collision situation to generate a collision mark.

8. The method for detecting wireless communication channel of claim 7, wherein the random back-off period comprises a first random back-off period and a second random back-off period, wherein the channel state parameters comprise a plurality of first channel state parameters and a plurality of second channel state parameters, wherein the first channel state parameters comprise one of a first number of interruptions, a first channel maximum idle time, a first random back-off count value and a first termination mark, wherein the second channel state parameters comprise one of a second number of interruptions, a second channel maximum idle time, a second random back-off count value and a second termination mark.

9. The method for detecting wireless communication channel of claim 8, wherein generating the channel state result according to the plurality of channel state parameters by the wireless communication device further comprises:
generating the total number of interruptions according to the first number of interruptions, the second number of interruptions and the collision mark; and
generating the random back-off count value according to the first random back-off count value, the second random back-off count value and the collision mark.

10. The method for detecting wireless communication channel of claim 1, wherein a channel type of the wireless communication channel comprises one of a voice data channel, a video data channel, a best effort data channel and a background data channel.

11. A wireless communication device, comprising:
a channel detection circuit, configured to detect a wireless communication signal of a wireless communication channel to determine whether to generate an idle channel evaluation signal;
a random back-off circuit, coupled to the channel detection circuit, and configured to count a random back-off period according to the idle channel evaluation signal;
a channel congestion statistics circuit, coupled to the random back-off circuit, and configured to record a plurality of channel state parameters of the random back-off period;
a channel congestion analysis circuit, coupled to the channel congestion statistics circuit, and configured to generate a channel state result according to the plurality of channel state parameters; and
a situational decision circuit, coupled to the channel congestion analysis circuit, and configured to determine an operation mode of the wireless communication device according to the channel state result.

12. The wireless communication device of claim 11, wherein if the wireless communication signal is detected, the channel detection circuit is further configured to generate the idle channel evaluation signal to stop the random back-off circuit from counting the random back-off period, wherein the wireless communication signal is not detected, the random back-off circuit is configured to count an arbitration inter-frame space period and continue to count the random back-off period.

13. The wireless communication device of claim 12, wherein the channel state parameters comprise one of a total number of interruptions, a channel maximum idle time, a random back-off count value and a termination mark, wherein the channel congestion statistics circuit is configured to record the total number of interruptions due to the idle channel evaluation signal that is stopped during the random back-off period by the wireless communication device, record the channel maximum idle time that is not stopped due to the idle channel evaluation signal during the random back-off period by the wireless communication device and record the random back-off count value of the random back-off period and the termination mark of the arbitration inter-frame space period by the wireless communication device.

14. The wireless communication device of claim 13, wherein the channel congestion analysis circuit is further configured to calculate a channel congestion evaluation value according to the total number of interruptions and the random back-off count value, wherein the channel congestion analysis circuit is further configured to comparing the channel congestion evaluation value with a preset congestion value to generate the channel state result.

15. The wireless communication device of claim 14, wherein if the channel state result is determined that the channel congestion evaluation value is less than the preset congestion value, the situational decision circuit is further configured not to adjust the operation mode of the wireless communication device.

16. The wireless communication device of claim 15, wherein if the channel state result is determined that the channel congestion evaluation value is greater than the preset congestion value, the situational decision circuit is further configured to adjust the operation mode of the wireless communication device.

17. The wireless communication device of claim 16, wherein after the wireless communication device counts the random back-off period, the wireless communication device is configured to transmit a data signal through the wireless communication channel, wherein the channel congestion statistics circuit is further configured to record whether the data signal transmitted by the wireless communication channel encounters a collision situation to generate a collision mark.

18. The wireless communication device of claim 17, wherein the random back-off period comprises a first random back-off period and a second random back-off period, wherein the channel state parameters comprise a plurality of first channel state parameters and a plurality of second channel state parameters, wherein the first channel state parameters comprise one of a first number of interruptions, a first channel maximum idle time, a first random back-off count value and a first termination mark, wherein the second channel state parameters comprise one of a second number of interruptions, a second channel maximum idle time, a second random back-off count value and a second termination mark.

19. The wireless communication device of claim 18, wherein the channel congestion analysis circuit is further configured to generate the total number of interruptions according to the first number of interruptions, the second number of interruptions and the collision mark, wherein the channel congestion analysis circuit is further configured to generate the random back-off count value according to the first random back-off count value, the second random back-off count value and the collision mark.

20. The wireless communication device of claim 11, further comprising:
a channel congestion statistics database, coupled between the channel congestion statistics circuit and the channel congestion analysis circuit, and configured to store the channel state parameters.
